(19) United States
(12) Patent Application Publication
(10) Pub. No.: US 2026/0198455 A1
(43) Pub. Date: Jul. 16, 2026

(54) CAT SCRATCHER

(71) Applicant: Fujian Fuhele Supply Chain Co., Ltd., Fuzhou (CN)

(72) Inventor: Jin HUANG, Fuzhou (CN)

(73) Assignee: Fujian Fuhele Supply Chain Co., Ltd., Fuzhou (CN)

(21) Appl. No.: 19/023,177

(22) Filed: Jan. 15, 2025

(51) Int. Cl. A01K 15/02

(52) U.S. Cl. CPC A01K 15/024

(57) ABSTRACT

Provided is a cat scratcher that can be changed into various shapes.The first cat scratch member includes a first fitting portion and a second fitting portion on a left end portion and a right end portion on an upper surface, and a first recess recessed downward between the left end portion and the right end portion on the upper surface. The second cat scratch member includes a third fitting portion and a fourth fitting portion on a left end portion and a right end portion on a lower surface, and a second recess that is recessed upward between the left end portion and the right end portion on the lower surface. When the second cat scratch member is placed on the first cat scratch member, the first recess and the second recess are combined to form one lateral hole portion that allows a cat to enter and exit.

### BACKGROUND

### 1. Technical Field

The present invention relates to a cat scratcher, and particularly to a cat scratcher that is also used as cat furniture.

### 2. Background Information

Claws of cats grow quickly and need to be scratched frequently. At home, cats scratch their claws on wooden furniture, which causes a lot of scratches on the furniture. Therefore, a cat scratcher that can be used indoors has been used in the related art.

FIG. 6 of JP7405339B discloses an invention of a cat scratcher in which a dome-shaped cover is attached to a box-shaped accommodation portion that accommodates a scratch member, allowing a cat to sleep inside. Further, FIG. 1 of JP3054686Y discloses a cat scratcher in which a scratch member is provided on a roof of triangular cat furniture having an empty interior.

A cat scratcher that is also used as cat furniture has an advantage of saving an installation space and costs for the cat furniture and the cat scratcher. However, the cat scratcher that is also used as cat furniture in the related art has a fixed shape as furniture, and cats are likely to be bored.

### BRIEF SUMMARY

### TECHNICAL PROBLEM

The present invention has been made in view of the above problem in the related art, and an object thereof is to provide a cat scratcher that can be changed into various shapes.

### SOLUTION TO PROBLEM

An invention according to claim 1 relates to a cat scratcher including:

a first cat scratch member and a second cat scratch member configured to be detachably fitted into two sections, a lower section and an upper section, in which

the first and second cat scratch members include a scratch laminate in which a plurality of plate-shaped corrugated cardboard pieces are overlapped in an upright state in a front-back direction,

the first cat scratch member is formed with a first recess that is recessed downward between a left end portion and a right end portion on an upper surface and extends in the front-back direction,

the left end portion and the right end portion on the upper surface of the first cat scratch member are respectively provided with a first fitting portion and a second fitting portion that extend in the front-back direction,

the second cat scratch member is formed with a second recess that is recessed upward between a left end portion and a right end portion on a lower surface and extends in the front-back direction,

the left end portion and the right end portion on the lower surface of the second cat scratch member are respectively provided with a third fitting portion and a fourth fitting portion that extend in the front-back direction,

when the second cat scratch member is placed on the first cat scratch member, the third fitting portion is detachably fitted to the first fitting portion, the fourth fitting portion is detachably fitted to the second fitting portion, and the first recess and the second recess are combined to form one lateral hole portion, and

the lateral hole portion has a space that allows a cat to enter and exit and lie down sideways.

In an invention according to claim 2,

the second cat scratch member is provided with a pair of ear portions respectively protruding upward from left and right sides of a top portion.

In an invention according to claim 3,

of the first fitting portion and the third fitting portion, one includes a fitting protrusion that protrudes toward the other and extends in the front-back direction, and the other includes a fitting groove configured to be detachably fitted to the fitting protrusion of the one and extending in the front-back direction, and

of the second fitting portion and the fourth fitting portion, one includes a fitting protrusion that protrudes toward the other and extends in the front-back direction, and the other includes a fitting groove configured to be detachably fitted to the fitting protrusion of the one and extending in the front-back direction.

An invention according to claim 4 relates to a cat scratcher including:

a first cat scratch member, a second cat scratch member, and a third cat scratch member configured to be detachably fitted into three sections, a lower section, an upper section, and a middle section, in which

the first, second, and third cat scratch members include a scratch laminate in which a plurality of plate-shaped corrugated cardboard pieces are overlapped in an upright state in a front-back direction,

the first cat scratch member is formed with a first recess that is recessed downward between a left end portion and a right end portion on an upper surface and extends in the front-back direction,

the left end portion and the right end portion on the upper surface of the first cat scratch member are respectively provided with a first fitting portion and a second fitting portion that extend in the front-back direction,

the second cat scratch member is formed with a second recess that is recessed upward between a left end portion and a right end portion on a lower surface and extends in the front-back direction,

the left end portion and the right end portion on the lower surface of the second cat scratch member are respectively provided with a third fitting portion and a fourth fitting portion that extend in the front-back direction,

the third cat scratch member is formed with a third recess that is recessed upward between a left end portion and a right end portion on a lower surface and extends in the front-back direction, and a fourth recess that is recessed downward between a left end portion and a right end portion on an upper surface and extends in the front-back direction,

the left end portion and the right end portion on the lower surface of the third cat scratch member are respectively provided with a fifth fitting portion and a sixth fitting portion that extend in the front-back direction, and the left end portion and the right end portion on the upper surface of the third cat scratch member are respectively provided with a seventh fitting portion and an eighth fitting portion that extend in the front-back direction,

when the third cat scratch member is placed on the first cat scratch member, the fifth fitting portion is detachably fitted to the first fitting portion, the sixth fitting portion is detachably fitted to the second fitting portion, and the first recess and the third recess are combined to form one first lateral hole portion,

the first lateral hole portion has a space that allows a cat to enter and exit and lie down sideways,

when the second cat scratch member is placed on the third cat scratch member, the third fitting portion is detachably fitted to the seventh fitting portion, the fourth fitting portion is detachably fitted to the eighth fitting portion, and the fourth recess and the second recess are combined to form one second lateral hole portion, and

the second lateral hole portion has a space that allows a cat to enter and exit and lie down sideways.

In an invention according to claim 5,

the second cat scratch member is provided with a pair of ear portions respectively protruding upward from left and right sides of a top portion.

In an invention according to claim 6,

of the first fitting portion and the fifth fitting portion, one includes a fitting protrusion that protrudes toward the other and extends in the front-back direction, and the other includes a fitting groove configured to be detachably fitted to the fitting protrusion of the one and extending in the front-back direction, and

of the second fitting portion and the sixth fitting portion, one includes a fitting protrusion that protrudes toward the other and extends in the front-back direction, and the other includes a fitting groove configured to be detachably fitted to the fitting protrusion of the one and extending in the front-back direction, and

of the seventh fitting portion and the third fitting portion, one includes a fitting protrusion that protrudes toward the other and extends in the front-back direction, and the other includes a fitting groove configured to be detachably fitted to the fitting protrusion of the one and extending in the front-back direction, and

of the eighth fitting portion and the fourth fitting portion, one includes a fitting protrusion that protrudes toward the other and extends in the front-back direction, and the other includes a fitting groove configured to be detachably fitted to the fitting protrusion of the one and extending in the front-back direction.

An invention according to claim 7 is the cat scratcher according to claim 4 or 5, in which

when the second cat scratch member is placed on the first cat scratch member, the third fitting portion is fitted to the first fitting portion, the fourth fitting portion is fitted to the second fitting portion, and the first recess and the second recess are combined to form one lateral hole portion, and

the lateral hole portion has a space that allows a cat to enter and exit and lie down sideways.

### ADVANTAGEOUS EFFECTS OF INVENTION

According to the invention according to claim 1, by placing the second cat scratch member on the first cat scratch member and fitting the members into two sections, a cat scratcher that can also be used as cat furniture, including one lateral hole portion which allows a cat to enter and exit and lie down sideways, can be achieved. By removing the second cat scratch member, the first cat scratch member can be used alone as a bed-shaped scratcher having a first recess that is recessed downward.

According to the invention according to claims 2 and 5, the second cat scratch member can be used alone as a bed-shaped scratcher having a second recess that is recessed downward, by being turned upside down.

According to the invention according to claim 3, the first cat scratch member and the second cat scratch member can be detachably fitted into two upper and lower sections by a fitting structure including the fitting protrusion and the fitting groove or the fitting groove and the fitting protrusion which are provided on the left end portions of the first and second cat scratch members and extend in the front-back direction, and a fitting structure including the fitting protrusion and the fitting groove or the fitting groove and the fitting protrusion which are provided on the right end portions of the first and second cat scratch members and extend in the front-back direction, and thus the second cat scratch member is less likely to be detached even when a cat enters and exits the lateral hole portion, and the structure is stable.

According to the invention according to claim 4, by placing the third cat scratch member on the first cat scratch member, placing the second cat scratch member on the third cat scratch member, and fitting the members into three upper, middle, and lower sections, a cat scratcher that can also be used as cat furniture including two upper and lower lateral hole portions, which allow a cat to enter and exit and lie down sideways, can be achieved. Even when the second cat scratch member is removed, the cat scratcher can also be used as cat furniture including one lateral hole portion, and furthermore, by removing the second and third cat scratch members, the first cat scratch member can be used alone as a bed-shaped scratcher having a first recess that is recessed downward. Further, the third cat scratch member can be used alone as a bed-shaped scratcher having a fourth recess that is recessed downward.

According to the invention according to claim 6, the first cat scratch member and the third cat scratch member can be detachably fitted into two upper and lower sections by a fitting structure including the fitting protrusion and the fitting groove which are provided on the left end portions of the first and third cat scratch members and extend in the front-back direction, and a fitting structure including the fitting protrusion and the fitting groove which are provided on the right end portions of the first and third cat scratch members and extend in the front-back direction, and thus the second cat scratch member is less likely to be detached even when a cat enters and exits the first lateral hole portion, and the structure is stable.

Further, the third cat scratch member and the second cat scratch member can be detachably fitted into two upper and lower sections by a fitting structure including the fitting protrusion and the fitting groove or the fitting groove and the fitting protrusion which are provided on the left end portions of the third and second cat scratch members and extend in the front-back direction, and a fitting structure including the fitting protrusion and the fitting groove or the fitting groove and the fitting protrusion which are provided on the right end portions of the second and third cat scratch members and extend in the front-back direction, and thus the third cat scratch member is less likely to be detached even when a cat enters and exits the second lateral hole portion, and the structure is stable.

According to the invention according to claim 7, by placing the second cat scratch member on the first cat scratch member and fitting the members, without using the third cat scratch member, the cat scratcher can be used as cat furniture, including a lateral hole portion obtained by combining the first recess portion and the second recess portion.

### BRIEF DESCRIPTION OF THE DRAWINGS

FIG. 1 is a front view of a cat scratcher according to a first embodiment of the present invention;

FIG. 2 is a plan view of FIG. 1;

FIG. 3 is a left side view of FIG. 1;

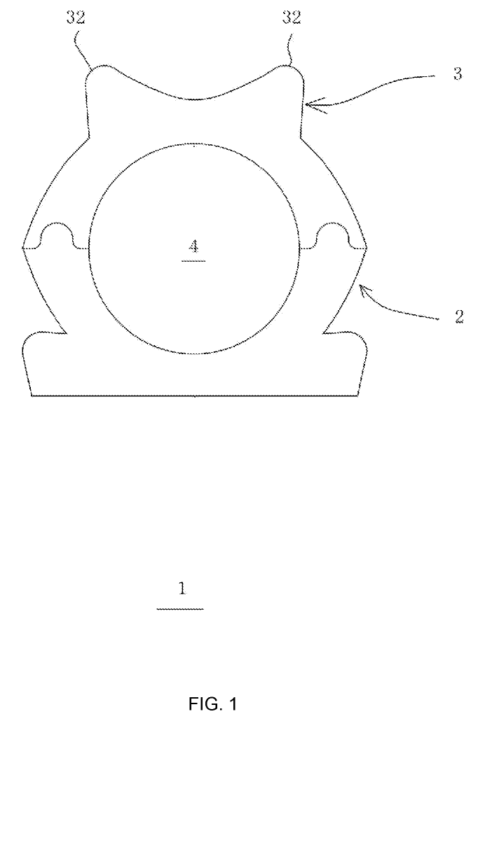

(1) to (3) in FIG. 4 are a front view, a plan view, and a left side view of a first cat scratch member in a lower section in FIG. 1, respectively;

(1) to (3) in FIG. 5 are a front view, a plan view, and a left side view of a corrugated cardboard piece constituting a scratch laminate in FIG. 4, respectively;

(1) to (3) in FIG. 6 are a front view, a plan view, and a left side view of a reinforcing corrugated cardboard piece in FIG. 4, respectively;

(1) to (3) in FIG. 7 are a front view, a plan view, and a left side view of a second cat scratch member in an upper section in FIG. 1, respectively;

(1) to (3) in FIG. 8 are a front view, a plan view, and a left side view of a corrugated cardboard piece in FIG. 7, respectively;

(1) to (3) in FIG. 9 are a front view, a plan view, and a left side view of a reinforcing corrugated cardboard piece in FIG. 7, respectively;

FIG. 10 is a diagram illustrating a method of assembling the cat scratcher in FIG. 1;

FIG. 11 is a diagram illustrating a method of using the second cat scratch member in FIG. 1;

FIG. 12 is a front view of a cat scratcher according to a second embodiment of the present invention;

FIG. 13 is a plan view of FIG. 12;

FIG. 14 is a left side view of FIG. 12;

(1) to (3) in FIG. 15 are a front view, a plan view, and a left side view of a third cat scratch member in a middle section in FIG. 12, respectively;

(1) to (3) in FIG. 16 are a front view, a plan view, and a left side view of a corrugated cardboard piece constituting a scratch laminate in FIG. 12, respectively;

(1) to (3) in FIG. 17 are a front view, a plan view, and a left side view of a reinforcing corrugated cardboard piece in FIG. 12, respectively;

FIG. 18 is a diagram illustrating a method of assembling the cat scratcher in FIG. 12;

FIG. 19 is a diagram illustrating the method of assembling the cat scratcher in FIG. 12; and

FIG. 20 is a diagram illustrating the method of assembling the cat scratcher in FIG. 12.

### DETAILED DESCRIPTION OF THE DRAWINGS AND THE PRESENTLY PREFERRED EMBODIMENTS

Hereinafter, preferred embodiments of the present invention will be described using examples.

### First Embodiment

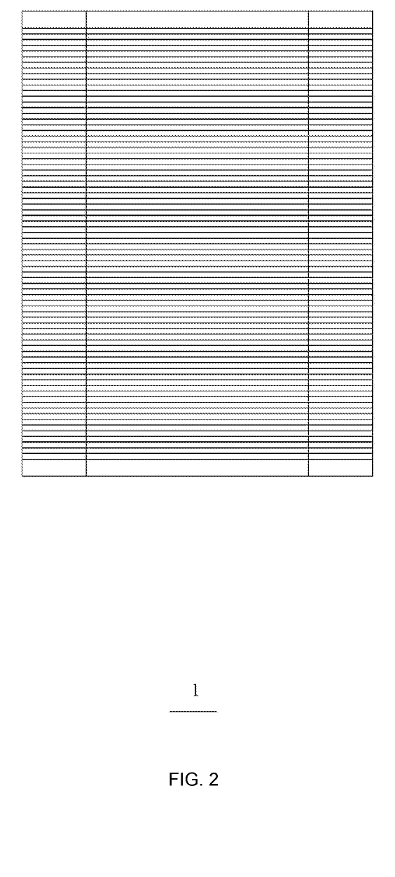

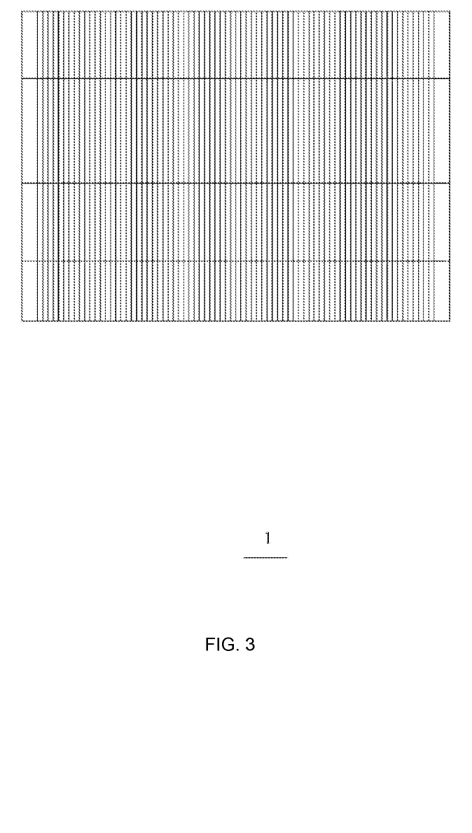

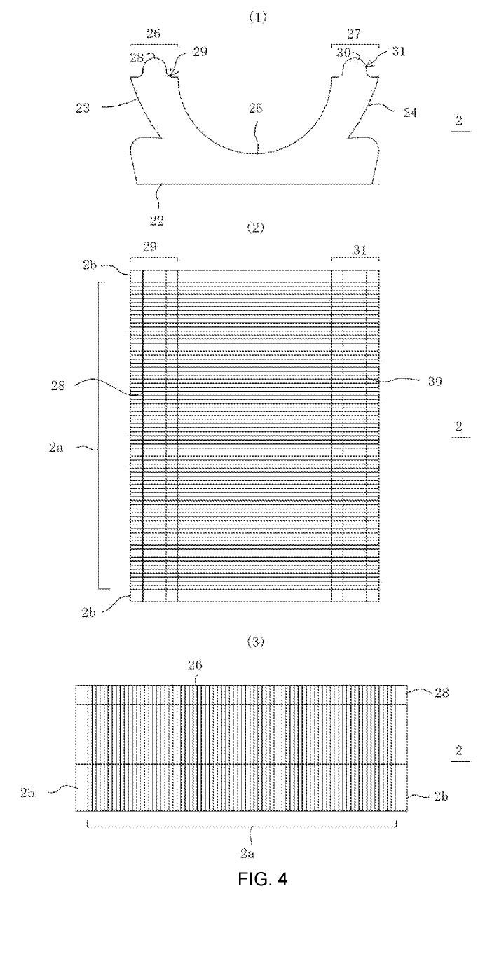

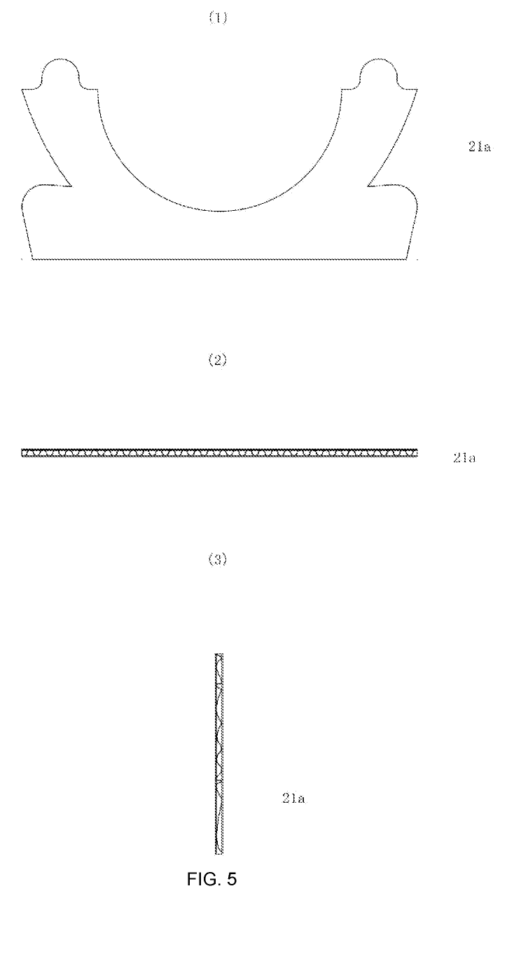

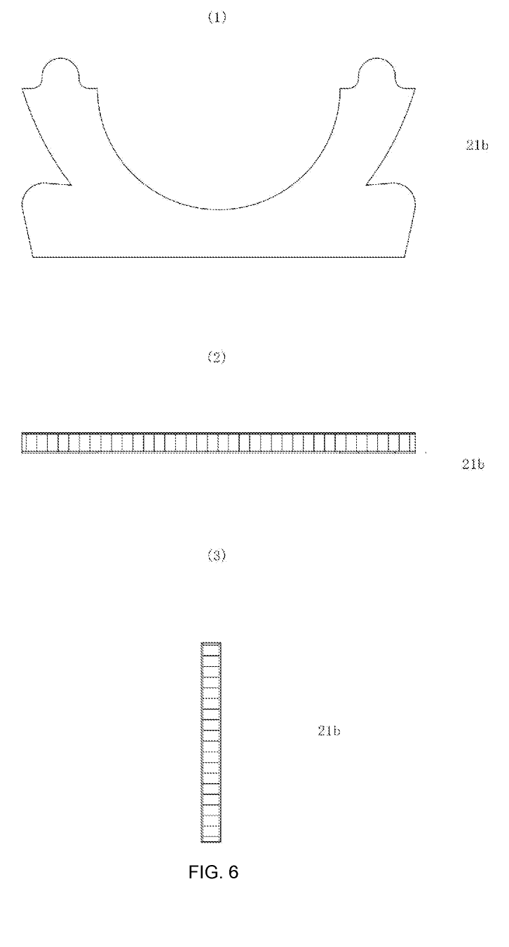

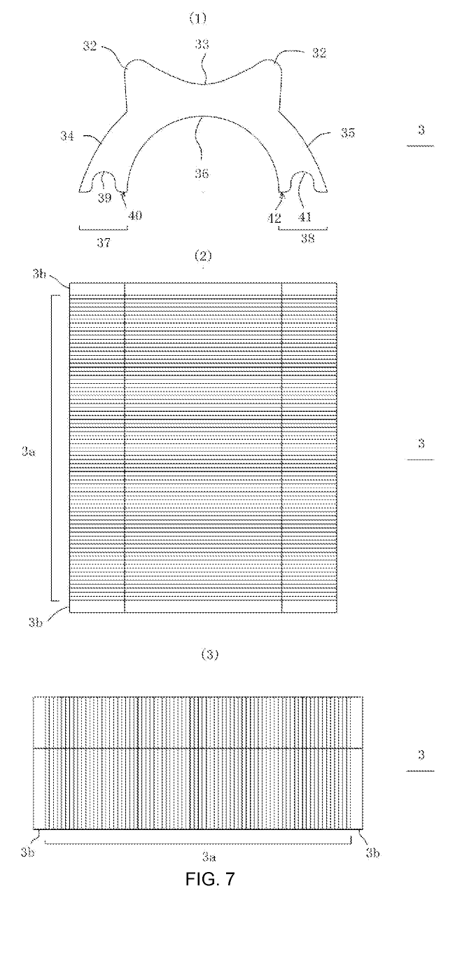

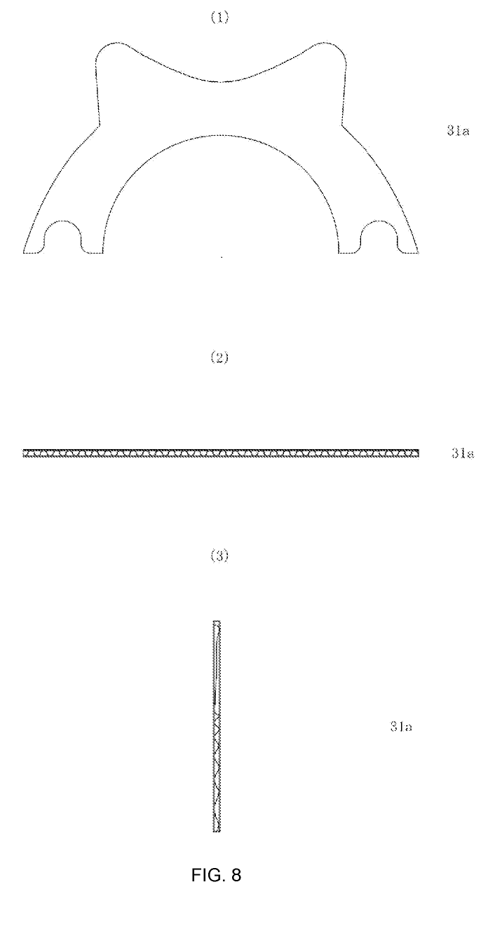

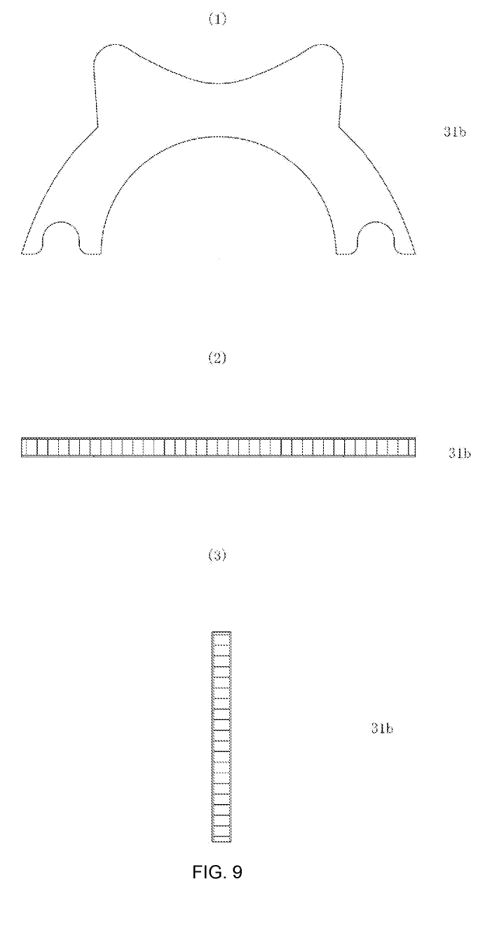

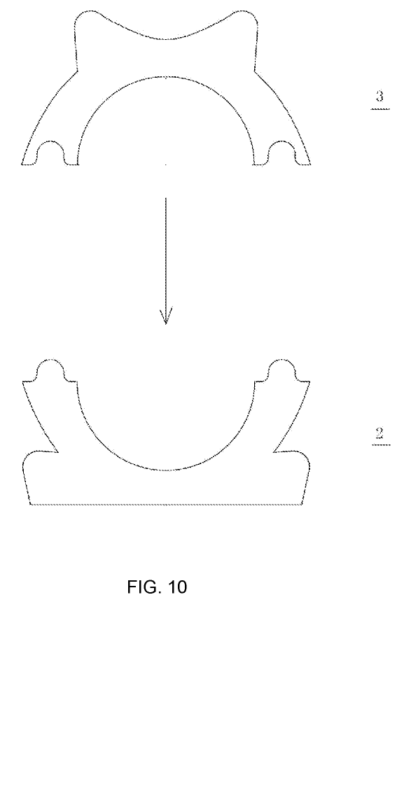

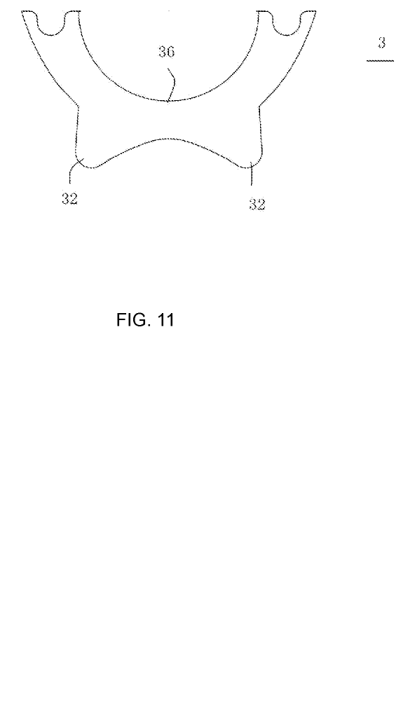

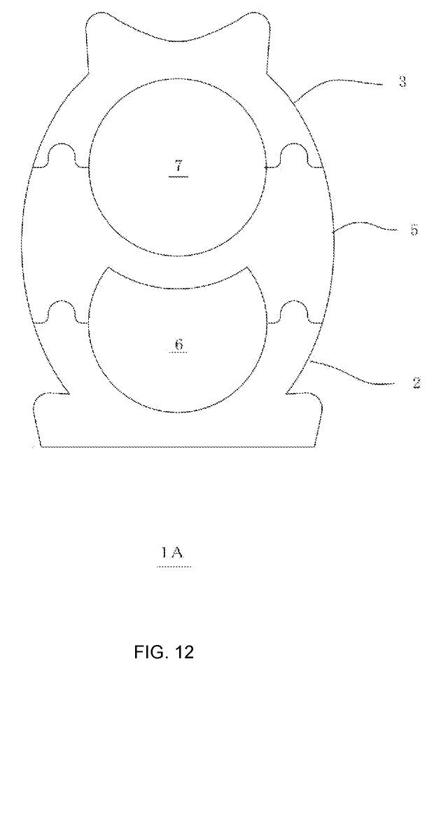

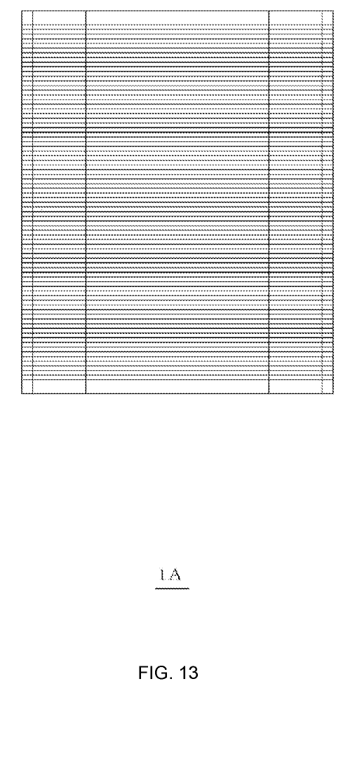

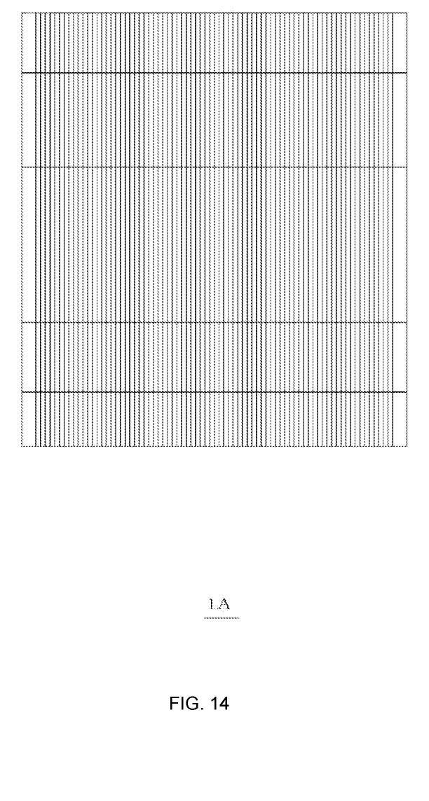

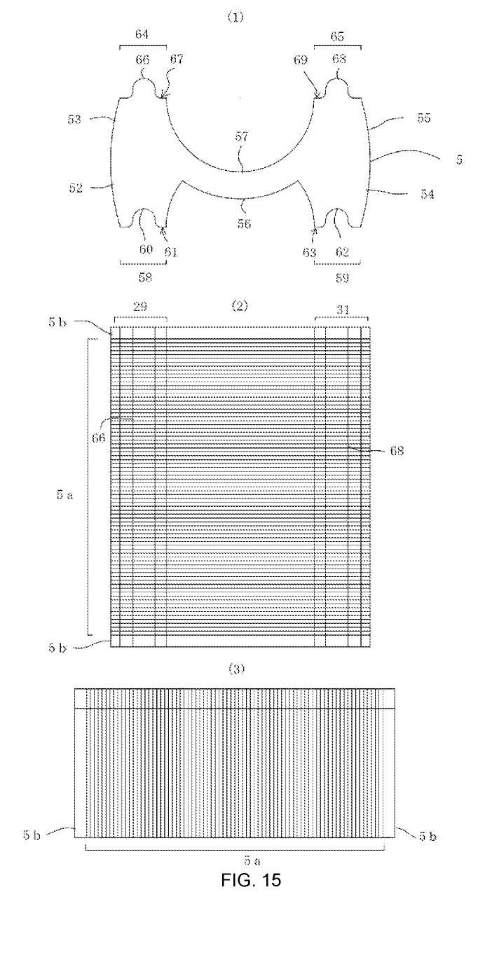

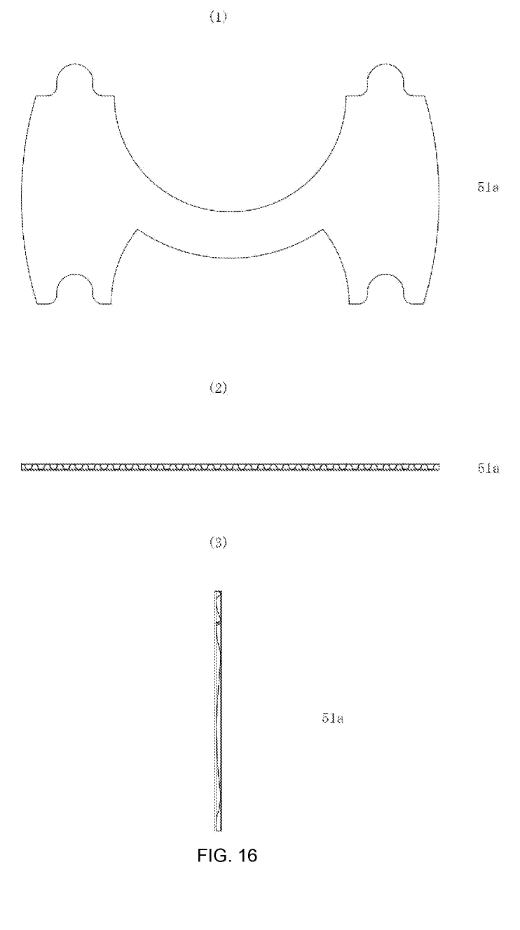

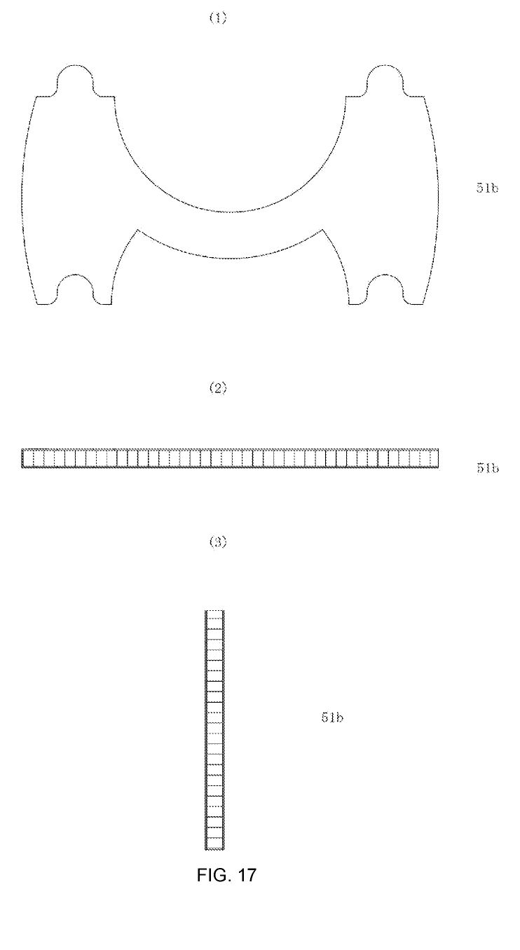

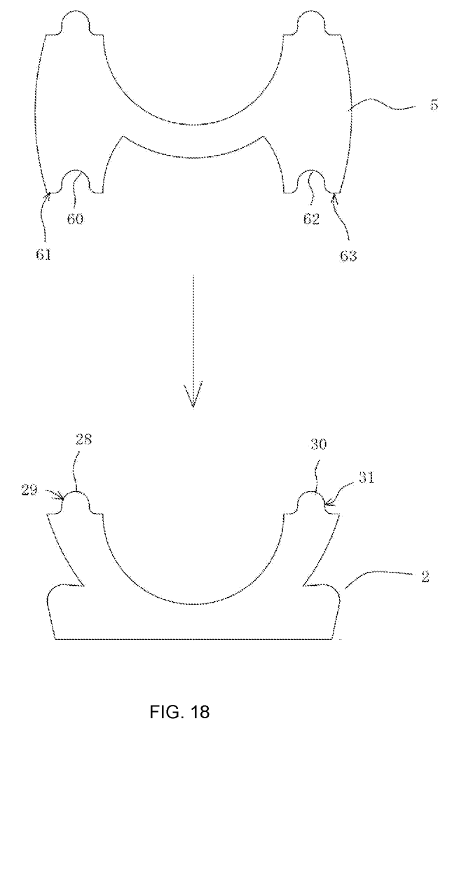

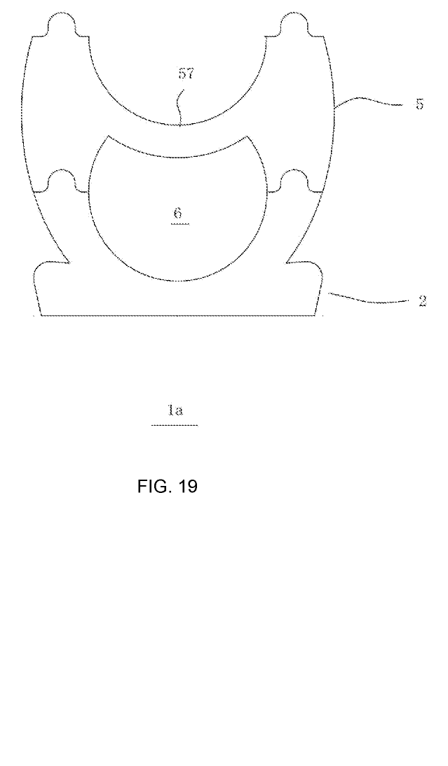

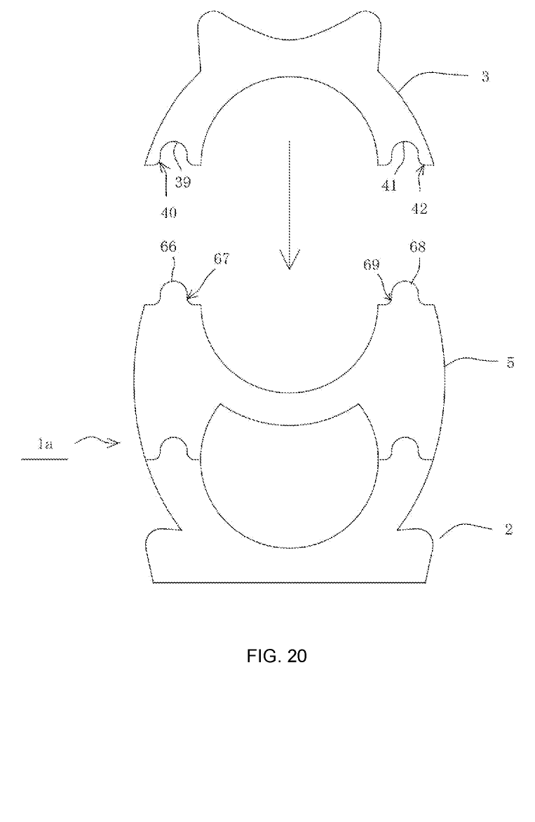

A cat scratcher according to a first embodiment of the present invention will be described with reference to FIGS. 1 to 8. FIG. 1 is a front view of the cat scratcher according to the first embodiment of the present invention; FIG. 2 is a plan view of FIG. 1; FIG. 3 is a left side view of FIG. 1; (1) to (3) in FIG. 4 are a front view, a plan view, and a left side view of a first cat scratch member in a lower section in FIG. 1, respectively; (1) to (3) in FIG. 5 are a front view, a plan view, and a left side view of a corrugated cardboard piece constituting a scratch laminate in FIG. 4, respectively; (1) to (3) in FIG. 6 are a front view, a plan view, and a left side view of a reinforcing corrugated cardboard piece in FIG. 4, respectively; (1) to (3) in FIG. 7 are a front view, a plan view, and a left side view of a second cat scratch member in an upper section in FIG. 1, respectively; (1) to (3) in FIG. 8 are a front view, a plan view, and a left side view of a corrugated cardboard piece constituting a scratch laminate in FIG. 7, respectively; (1) to (3) in FIG. 9 are a front view, a plan view, and a left side view of a reinforcing corrugated cardboard piece in FIG. 7, respectively; FIG. 10 is a diagram illustrating a method of assembling the cat scratcher in FIG. 1; and FIG. 11 is a diagram illustrating a method of using the second cat scratch member.

In these figures, a reference numeral 1 represents a cat scratcher made of a plurality of corrugated cardboard pieces. The cat scratcher 1 is implemented by a combination of first and second cat scratch members 2 and 3 in a lower section and an upper section, and can also be used as cat furniture. Specifically, the cat scratcher 1 has a tunnel-shaped lateral hole portion 4. The lateral hole portion 4 has an internal space, and a cat can enter and exit the internal space of the lateral hole portion 4 or can lie down sideways in the internal space. The first and second cat scratch members 2 and 3 are each symmetrically formed.

The first cat scratch member 2 in the lower section has a cup shape with a base in a front view (see FIG. 4). The first cat scratch member 2 includes a scratch laminate 2a in which a plurality of corrugated cardboard pieces 21a having the same shape in a flat plate shape are overlapped upright in a front-back direction and integrated by adhesion, and integration is performed by adhering thick plate-shaped reinforcing corrugated cardboard pieces 21b having the same shape as the corrugated cardboard pieces 21a in a plan view in the front-back direction. The corrugated cardboard pieces 21a and 21b each have a cup shape with a base at a lower end portion (see FIGS. 5 and 6).

The first cat scratch member 2 includes a base portion 22, a left rising portion 23, a right rising portion 24, and a first recess 25 between these portions, which is recessed downward, faces upward, and has a large diameter. A left end portion 26 (upper surface of the left rising portion 23) and a right end portion 27 (upper surface of the right rising portion 24) on an upper surface of the first cat scratch member 2 have the same height. The left end portion 26 on the upper surface forms a wave-shaped first fitting portion 29 that includes a central mountain-shaped fitting protrusion 28, and the right end portion 27 on the upper surface forms a wave-shaped second fitting portion 31 that includes a central mountain-shaped fitting protrusion 30. The fitting protrusion 28 protrudes upward toward a third fitting portion (reference numeral 40 in FIG. 7) of the second cat scratch member 3 to be described later, and the fitting protrusion 30 protrudes upward toward a fourth fitting portion (reference numeral 42 in FIG. 7) to be described later.

The upper surface of the first cat scratch member 2 is a scratch surface.

The second cat scratch member 3 in the upper section has a downward cup shape in a front view (see FIG. 7). The second cat scratch member 3 includes a scratch laminate 3a in which a plurality of corrugated cardboard pieces 31a having the same shape in a flat plate shape are overlapped upright in the front-back direction and integrated by adhesion, and integration is performed by adhering thick plate-shaped reinforcing corrugated cardboard pieces 31b having the same shape as the corrugated cardboard pieces 31a in a plan view in the front-back direction. The corrugated cardboard pieces 31a and 31b each have a downward cup shape with ears on left and right sides of an upper end portion (see FIGS. 8 and 9).

The second cat scratch member 3 includes a top portion 33 having a pair of left and right ear portions 32, 32, a left falling portion 34, a right falling portion 35, and a second recess 36 between these portions, which is recessed upward, faces downward, and has a large diameter. A left end portion 37 (lower surface of the left falling portion 34) and a right end portion 38 (lower surface of the right falling portion 35) on a lower surface of the second cat scratch member 3 have the same height. The left end portion 37 on the lower surface forms the wave-shaped third fitting portion 40 that includes a central valley-shaped fitting groove 39, and the right end portion 38 on the lower surface forms the wave-shaped second fitting portion 42 that includes a central valley-shaped fitting groove 41. The fitting groove 39 can be detachably fitted to the fitting protrusion 28, and the fitting groove 41 can be detachably fitted to the fitting protrusion 30.

The lower surface of the second cat scratch member 3 is a scratch surface.

When the second cat scratch member 3 is placed on the first cat scratch member 2 from above and pressed down, the third fitting portion 40 is detachably fitted to the first fitting portion 29, and at this time, the fitting groove 39 is detachably fitted to the fitting protrusion 28, and at the same time, the fourth fitting portion 42 is detachably fitted to the second fitting portion 31, and the fitting groove 41 is detachably fitted to the fitting protrusion 30, thereby integrating the first and second cat scratch members 2 and 3. The first recess 25 and the second recess 36 are combined to form one lateral hole portion 4. The lateral hole portion 4 has a space that allows a cat to enter and exit and lie down sideways inside. Further, an entire inner surface of the lateral hole portion 4 is a scratch surface, and the cat can enter and scratch claws.

Next, a method of using the cat scratcher according to the first embodiment described above will be described.

The first cat scratch member 2 can be used alone as a bed-shaped cat scratcher having an upper surface as a scratch surface (see FIG. 4).

The second cat scratch member 3 is placed on the first cat scratch member 2 and pressed down, the first fitting portion 29 and the third fitting portion 40 are fitted to each other, and the fourth fitting portion 42 is fitted to the second fitting portion 31, whereby the first and second cat scratch members 2 and 3 can be used as the house-shaped cat scratcher 1 including the lateral hole portion 4 that allows a cat to enter and exit and lie down sideways (see FIGS. 10 and 1).

When the second cat scratch member 3 is turned upside down such that the second recess 36 faces upward and is supported by the left and right ear portions 32, the second cat scratch member 3 can also be used as a bed-shaped cat scratcher having an upper surface as a scratch surface (see FIG. 11).

According to this embodiment, by placing the second cat scratch member 3 on the first cat scratch member 2 and fitting the members into two upper and lower sections, the cat scratcher 1 that can also be used as cat furniture, including one lateral hole portion which allows a cat to enter and exit and lie down sideways, can be achieved. By removing the second cat scratch member 3, the first cat scratch member 2 can be used alone as a bed-shaped scratcher having the first recess 25 that is recessed downward. Further, the second cat scratch member 3 can be used alone as a bed-shaped scratcher having the second recess 36 that is recessed downward, by being turned upside down.

Further, the first cat scratch member 2 and the second cat scratch member 3 can be detachably fitted into two upper and lower sections by a fitting structure including the fitting protrusion 28 and the fitting groove 39, which are provided on the left end portions of the first and second cat scratch members 2 and 3 and extend in the front-back direction, and a fitting structure including the fitting protrusion 30 and the fitting groove 41, which are provided on the right end portions of the first and second cat scratch members 2 and 3 and extend in the front-back direction, and thus the second cat scratch member 3 is less likely to be detached even when a cat enters and exits the lateral hole portion 4, and the structure is stable.

### Second Embodiment

Next, a cat scratcher according to a second embodiment of the present invention will be described with reference to FIGS. 12 to 20. FIG. 12 is a front view of the cat scratcher according to the second embodiment of the present invention; FIG. 13 is a plan view of FIG. 12; FIG. 14 is a left side view of FIG. 12; (1) to (3) in FIG. 15 are a front view, a plan view, and a left side view of a third cat scratch member in a middle section in FIG. 12, respectively; (1) to (3) in FIG. 16 are a front view, a plan view, and a left side view of a corrugated cardboard piece constituting a scratch laminate in FIG. 12, respectively; (1) to (3) in FIG. 17 are a front view, a plan view, and a left side view of a reinforcing corrugated cardboard piece in FIG. 12, respectively; and FIGS. 18 to 20 are diagrams illustrating a method of assembling the cat scratcher in FIG. 12. The same components as those of the first embodiment described above are denoted by the same reference numerals.

The second embodiment is a cat scratcher that is also used as cat furniture in which cat scratch members in three upper, middle, and lower sections are combined, and two upper and lower lateral hole portions can be formed by combining the cat scratch members into three sections.

In FIGS. 12 to 14, a reference numeral 1A represents a cat scratcher made of a plurality of corrugated cardboard pieces. The cat scratcher 1A is implemented by a combination of three upper, middle, and lower sections, that is, the first and second cat scratch members 2 and 3 in the lower and upper sections and a third cat scratch member 5 in the middle section, and can also be used as cat furniture. Specifically, the cat scratcher 1A has two upper and lower first and second lateral hole portions 6 and 7 having a tunnel shape, and a cat can enter and exit internal spaces of the first and second lateral hole portions 6 and 7 or can lie down sideways in the internal spaces. The first, second, and third cat scratch members 2, 3, and 5 are each symmetrically formed.

The third cat scratch member 5 has a gutter shape in a front view (see FIG. 15). The third cat scratch member 5 includes a scratch laminate 5a in which a plurality of corrugated cardboard pieces 51a having the same shape in a flat plate shape are overlapped upright in the front-back direction and integrated by adhesion, and integration is performed by adhering thick plate-shaped reinforcing corrugated cardboard pieces 51b having the same shape as the corrugated cardboard pieces 51a in a plan view in the front-back direction (see FIGS. 16 and 17).

The third cat scratch member 5 includes a left falling portion 52 and a left rising portion 53 at a left end portion, and a right falling portion 54 and a right rising portion 55 at a right end portion. The third cat scratch member 5 includes a third recess 56 that is recessed upward between the left falling portion 52 at the left end portion and the right falling portion 54 at the right end portion, and a fourth recess 57 that has a large diameter and is recessed downward between the left rising portion 53 at the left end portion and the right rising portion 55 at the right end portion.

A left end portion 58 (lower surface of the left falling portion 52) and a right end portion 59 (lower surface of the right falling portion 54) on a lower surface of the third cat scratch member 5 have the same height. The left end portion 58 on the lower surface forms a wave-shaped fifth fitting portion 61 that includes a central valley-shaped fitting groove 60, and the right end portion 59 on the lower surface forms a wave-shaped sixth fitting portion 63 that includes a central valley-shaped fitting groove 62. The fitting groove 60 can be detachably fitted to the fitting protrusion 28 of the first cat scratch member 2, and the fitting groove 62 can be detachably fitted to the fitting protrusion 30.

The fitting protrusion 28 of the first cat scratch member 2 protrudes upward toward the fifth fitting portion 61 of the third cat scratch member 5, and the fitting protrusion 30 protrudes upward toward the sixth fitting portion 63.

A left end portion 64 (upper surface of the left rising portion 53) and a right end portion 65 (upper surface of the right rising portion 55) on an upper surface of the third cat scratch member 5 have the same height. The left end portion 64 on the upper surface forms a wave-shaped seventh fitting portion 67 that includes a central mountain-shaped fitting protrusion 66, and the right end portion 65 on the upper surface forms a wave-shaped eighth fitting portion 69 that includes a central mountain-shaped fitting protrusion 68. The fitting protrusion 66 protrudes upward toward the third fitting portion 40 of the second cat scratch member 3, and the fitting protrusion 30 protrudes upward toward the fourth fitting portion 42. The fitting protrusion 66 can be detachably fitted into the fitting groove 39, and the fitting protrusion 68 can be detachably fitted into the fitting groove 41.

The upper surface and the lower surface of the third cat scratch member 5 are scratch surfaces.

When the third cat scratch member 5 is placed on the first cat scratch member 2 from above and pressed down, the fifth fitting portion 61 is detachably fitted to the first fitting portion 29, and at this time, the fitting groove 60 is detachably fitted to the fitting protrusion 28, and at the same time, the sixth fitting portion 63 is detachably fitted to the second fitting portion 31, and the fitting groove 62 is detachably fitted to the fitting protrusion 30, thereby integrating the first and third cat scratch members 2 and 5. The first recess 25 and the third recess 56 are combined to form one first lateral hole portion 6. The first lateral hole portion 6 has a space that allows a cat to enter and exit and lie down sideways inside. Further, an entire inner surface of the first lateral hole portion 6 is a scratch surface, and the cat can enter and scratch claws.

When the second cat scratch member 3 is placed on the third cat scratch member 5 from above and pressed down, the third fitting portion 40 is detachably fitted to the seventh fitting portion 67, and at this time, the fitting groove 39 is detachably fitted to the fitting protrusion 66, and at the same time, the fourth fitting portion 42 is detachably fitted to the eighth fitting portion 69, and at this time, the fitting groove 41 is detachably fitted to the fitting protrusion 68, thereby integrating the second and third cat scratch members 3 and 5. The fourth recess 57 and the second recess 36 are combined to form one second lateral hole portion 7. The second lateral hole portion 7 has a space that allows a cat to enter and exit and lie down sideways inside. Further, an entire inner surface of the second lateral hole portion 7 is a scratch surface, and the cat can enter and scratch claws.

The first and second cat scratch members 2 and 3 have the same configuration as that of the first embodiment.

Next, a method of using the cat scratcher according to the second embodiment described above will be described.

The first cat scratch member 2 can be used alone as a bed-shaped cat scratcher having an upper surface as a scratch surface (see FIG. 4).

When the second cat scratch member 3 is turned upside down such that the second recess 36 faces upward and is supported by the left and right ear portions 32, the second cat scratch member 3 can also be used as a bed-shaped cat scratcher having an upper surface as a scratch surface (see FIG. 11).

The third cat scratch member 5 can be used alone as a bed-shaped cat scratcher having an upper surface as a scratch surface (see FIG. 15).

The third cat scratch member 5 is placed on the first cat scratch member 2 and pressed down, the first fitting portion 29 and the fifth fitting portion 61 are fitted to each other, and the sixth fitting portion 63 is fitted to the second fitting portion 31, whereby the first and third cat scratch members 2 and 5 can be used as a house-shaped cat scratcher 1a including the lateral hole portion 6 that allows a cat to enter and exit and lie down sideways (see FIGS. 14 and 15). The upper surface of the third cat scratch member 5 has a bed shape. The cat can scratch claws on both the inner surface of the first lateral hole portion 6 and the upper surface of the cat scratch member 5.

The second cat scratch member 3 is further placed on the cat scratcher 1a in FIG. 19 and pressed down, the seventh fitting portion 67 and the third fitting portion 40 are fitted to each other, and the fourth fitting portion 42 is fitted to the eighth fitting portion 69, whereby the cat scratcher 1a and the second cat scratch member 3 can be used as the fish-shaped cat scratcher 1A including the two upper and lower first and second lateral hole portions 6 and 7 that allow a cat to enter and exit and lie down sideways (see FIGS. 20 and 12). The cat can scratch claws on the inner surfaces of the first and second lateral hole portions 6 and 7.

Further, the second cat scratch member 3 is placed on the first cat scratch member 2 and pressed down, the first fitting portion 29 and the third fitting portion 40 are fitted to each other, and the fourth fitting portion 42 is fitted to the second fitting portion 31, whereby the first and second cat scratch members 2 and 3 can be used as the house-shaped cat scratcher 1 including the lateral hole portion 4 that allows a cat to enter and exit and lie down sideways (see FIGS. 10 and 1).

According to the second embodiment, by placing the third cat scratch member 5 on the first cat scratch member 2, placing the second cat scratch member 3 on the third cat scratch member 5, and fitting the members into three upper, middle, and lower sections, the cat scratcher 1A that can also be used as cat furniture, including the two upper and lower first and second lateral hole portions 6 and 7 which allow a cat to enter and exit and lie down sideways, can be achieved. Even when the second cat scratch member 3 is removed, the first and third cat scratch members 2 and 5 can be used as the cat scratcher 1a including one lateral hole portion, and furthermore, the first cat scratch member 2 and third cat scratch member 5 can be used alone as a bed-shaped scratcher having the first recess 25 or the fourth recess 57 that is recessed downward. The second cat scratch member 3 can be used alone as a bed-shaped scratcher having the second recess 36 that is recessed downward, by being turned upside down.

By fitting the first cat scratch member 2 and the second cat scratch member 3 into two upper and lower sections, the first cat scratch member 2 and the second cat scratch member 3 can be used as the cat scratcher 1 that is also used as cat furniture including one lateral hole portion 4.

The first cat scratch member 2 and the third cat scratch member 5 can be detachably fitted vertically by a fitting structure including the fitting protrusion 28 and the fitting groove 60, which are provided on the left end portions and extend in the front-back direction, and a fitting structure including the fitting protrusion 30 and the fitting groove 62, which are provided on the right end portions and extend in the front-back direction, and thus the third cat scratch member 5 is less likely to be detached even when a cat enters and exits the lateral hole portion 6, and the structure is stable.

Further, the third cat scratch member 5 and the second cat scratch member 3 can be detachably fitted vertically by a fitting structure including the fitting protrusion 66 and the fitting groove 39, which are provided on the left end portions and extend in the front-back direction, and a fitting structure including the fitting protrusion 68 and the fitting groove 41, which are provided on the right end portions and extend in the front-back direction, and thus the second cat scratch member 3 is less likely to be detached even when a cat enters and exits the lateral hole portion 7, and the structure is stable.

In the first and second embodiments described above, the fitting protrusions are provided in the first and second fitting portions of the first cat scratch member and the seventh and eighth fitting portions of the third cat scratch member, and the fitting grooves are provided in the third and fourth fitting portions and the fifth and sixth fitting portions. However, conversely, the fitting grooves may be provided in the first and second fitting portions of the first cat scratch member and the seventh and eighth fitting portions of the third cat scratch member, and the fitting protrusions may be provided in the third and fourth fitting portions and the fifth and sixth fitting portions.

### INDUSTRIAL APPLICABILITY

The present invention can be applied to a cat scratcher for a cat kept indoors at home or the like.

### REFERENCE SIGN LIST

1, 1A, 1a cat scratcher

2 first cat scratch member

3 second cat scratch member

4 lateral hole portion

5 third cat scratch member

6 first lateral hole portion

7 second lateral hole portion

21a, 21b, 31a, 31b, 51a, 51b corrugated cardboard piece

25 first recess

36 second recess

56 third recess

57 fourth recess

28, 30, 66, 68 fitting protrusion

29 first fitting portion

31 second fitting portion

39, 41, 60, 62 fitting groove

40 third fitting portion

42 fourth fitting portion

61 fifth fitting portion

63 sixth fitting portion

67 seventh fitting portion

69 eighth fitting portion

1. A cat scratcher comprising:
a first cat scratch member and a second cat scratch member configured to be detachably fitted into two sections, a lower section and an upper section, wherein
the first and second cat scratch members each include a scratch laminate in which a plurality of plate-shaped corrugated cardboard pieces are overlapped in an upright state in a front-back direction,
the first cat scratch member is formed with a first recess that is recessed downward between a left end portion and a right end portion on an upper surface and extends in the front-back direction,
the left end portion and the right end portion on the upper surface of the first cat scratch member are respectively provided with a first fitting portion and a second fitting portion that extend in the front-back direction,
the second cat scratch member is formed with a second recess that is recessed upward between a left end portion and a right end portion on a lower surface and extends in the front-back direction,
the left end portion and the right end portion on the lower surface of the second cat scratch member are respectively provided with a third fitting portion and a fourth fitting portion that extend in the front-back direction,
when the second cat scratch member is placed on the first cat scratch member, the third fitting portion is detachably fitted to the first fitting portion, the fourth fitting portion is detachably fitted to the second fitting portion, and the first recess and the second recess are combined to form one lateral hole portion, and
the lateral hole portion has a space that allows a cat to enter and exit and lie down sideways.

2. The cat scratcher according to claim 1, wherein
the second cat scratch member is provided with a pair of ear portions respectively protruding upward from left and right sides of a top portion.

3. The cat scratcher according to claim 1, wherein
of the first fitting portion and the third fitting portion, one includes a fitting protrusion that protrudes toward the other and extends in the front-back direction, and the other includes a fitting groove configured to be detachably fitted to the fitting protrusion of the one and extending in the front-back direction, and
of the second fitting portion and the fourth fitting portion, one includes a fitting protrusion that protrudes toward the other and extends in the front-back direction, and the other includes a fitting groove configured to be detachably fitted to the fitting protrusion of the one and extending in the front-back direction.

4. A cat scratcher comprising:
a first cat scratch member, a second cat scratch member, and a third cat scratch member configured to be detachably fitted into three sections, a lower section, an upper section, and a middle section, wherein
the first, second, and third cat scratch members each include a scratch laminate in which a plurality of plate-shaped corrugated cardboard pieces are overlapped in an upright state in a front-back direction,
the first cat scratch member is formed with a first recess that is recessed downward between a left end portion and a right end portion on an upper surface and extends in the front-back direction,
the left end portion and the right end portion on the upper surface of the first cat scratch member are respectively provided with a first fitting portion and a second fitting portion that extend in the front-back direction,
the second cat scratch member is formed with a second recess that is recessed upward between a left end portion and a right end portion on a lower surface and extends in the front-back direction,
the left end portion and the right end portion on the lower surface of the second cat scratch member are respectively provided with a third fitting portion and a fourth fitting portion that extend in the front-back direction,
the third cat scratch member is formed with a third recess that is recessed upward between a left end portion and a right end portion on a lower surface and extends in the front-back direction, and a fourth recess that is recessed downward between a left end portion and a right end portion on an upper surface and extends in the front-back direction,
the left end portion and the right end portion on the lower surface of the third cat scratch member are respectively provided with a fifth fitting portion and a sixth fitting portion that extend in the front-back direction, and the left end portion and the right end portion on the upper surface of the third cat scratch member are respectively provided with a seventh fitting portion and an eighth fitting portion that extend in the front-back direction,
when the third cat scratch member is placed on the first cat scratch member, the fifth fitting portion is detachably fitted to the first fitting portion, the sixth fitting portion is detachably fitted to the second fitting portion, and the first recess and the third recess are combined to form one first lateral hole portion,
the first lateral hole portion has a space that allows a cat to enter and exit and lie down sideways,
when the second cat scratch member is placed on the third cat scratch member, the third fitting portion is detachably fitted to the seventh fitting portion, the fourth fitting portion is detachably fitted to the eighth fitting portion, and the fourth recess and the second recess are combined to form one second lateral hole portion, and
the second lateral hole portion has a space that allows a cat to enter and exit and lie down sideways.

5. The cat scratcher according to claim 4, wherein
the second cat scratch member is provided with a pair of ear portions respectively protruding upward from left and right sides of a top portion.

6. The cat scratcher according to claim 4, wherein
of the first fitting portion and the fifth fitting portion, one includes a fitting protrusion that protrudes toward the other and extends in the front-back direction, and the other includes a fitting groove configured to be detachably fitted to the fitting protrusion of the one and extending in the front-back direction, and
of the second fitting portion and the sixth fitting portion, one includes a fitting protrusion that protrudes toward the other and extends in the front-back direction, and the other includes a fitting groove configured to be detachably fitted to the fitting protrusion of the one and extending in the front-back direction, and
of the seventh fitting portion and the third fitting portion, one includes a fitting protrusion that protrudes toward the other and extends in the front-back direction, and the other includes a fitting groove configured to be detachably fitted to the fitting protrusion of the one and extending in the front-back direction, and
of the eighth fitting portion and the fourth fitting portion, one includes a fitting protrusion that protrudes toward the other and extends in the front-back direction, and the other includes a fitting groove configured to be detachably fitted to the fitting protrusion of the one and extending in the front-back direction.

7. The cat scratcher according to claim 4, wherein
when the second cat scratch member is placed on the first cat scratch member, the third fitting portion is fitted to the first fitting portion, the fourth fitting portion is fitted to the second fitting portion, and the first recess and the second recess are combined to form one lateral hole portion, and
the lateral hole portion has a space that allows a cat to enter and exit and lie down sideways.
